(19) United States
(12) Patent Application Publication
(10) Pub. No.: US 2009/0212176 A1
(43) Pub. Date: Aug. 27, 2009

(54) Utensil storage stand

(76) Inventors: David Lee Cass, Greensburg, PA (US); Marilyn Kathryn Cass, Greensburg, PA (US)

Correspondence Address: Lawrence R. Burn, Esquire, 310 Coulter Building, 231 South Main Street, Greensburg, PA, 15601, US

(21) Appl. No.: 12/383,207

(22) Filed: Mar. 20, 2009

Related U.S. Application Data
(63) Continuation-in-part of application No. 11/805,111, filed on May 22, 2007.

(51) Int. Cl. F16M 11/26; F16M 11/22

(52) U.S. Cl. 248/125.8; 248/121

(57) ABSTRACT

This invention has to do with a utensil storage stand, which comprises a base, a column extending away from the base, a distal end on the column, and utensil engaging means rotatably mounted on the column. The utensil engaging means is rotatably mounted on the distal end of the column by a ball bearing arrangement comprising plastic races co-operating with plastic or ceramic bearings interposed between the races. The utensil engagement means comprises radially extending spokes with enlarged perforations through the spokes and utensil support hooks extending from the spokes. The utensil engagement means is rotatably mounted with respect to column having an axis substantially perpendicular to the plane of the base. The radial support spokes preferably have support apertures and hooks so that utensils may be stored and efficiently positioned on the storage stand.

### RELATED APPLICATIONS

This application is a Continuation-in-Part application of co-pending application Ser. No. 11/805,111 filed May 22, 2007 Entitled Utensil Storage Stand by the same inventors.

### BACKGROUND OF THE INVENTION

Preparation of food in the kitchen sometimes is a quite complex affair requiring many pots, pans and kitchen utensils. Pots and pans are usually stored out of sight in the kitchen area and a majority of utensils may be stored in a drawer that is convenient to the food preparation area. Utensils may also be stored on a countertop that is near and convenient to the food preparation area. In preparing food or following a recipe the sequential use of many cooking utensils, and even the repeated use of the same utensil may be required, in which case it would be desirable to have a nearby and convenient place to store multiple utensils.

Typically some form of open topped canister may be used to store numerous utensils on a countertop with no organization to the assembly of utensils that are accumulated in the canister. The open topped canister has the drawback of trapping and collecting dust and debris through its open top while also having the further disadvantage that the utensils may become tangled with one another and not easily withdrawn from the canister. In addition if utensils are placed in the canister just after being washed they may drip some moisture into the bottom of the canister where it can accumulate and create unhealthy conditions. Limited space on a countertop also limits the use of canisters because the utensils in the back of the canister are not easily accessible with the utensils in the front of the canister blocking an easy reach to the rear of the canister. The canister or area that is usually available for the storage of utensils may be typically below the kitchen cabinets thereby limiting the space above the canister that is available to reach the utensils in the rear of the canister. Utensil stands are known from which one may hang, a utensil but either do not provide for rotation of the utensils or the compact storage of the utensils that are stored on the unit.

Many utensils used in the kitchen have perforations in their handles that are there for the purpose of hanging the utensils when not in use. Putting these utensils in drawers or upside down in canisters does not utilize the perforations as originally intended by the manufacturer. Hanging the utensils on known non-rotatable and non-compact stands takes up too much counter space and is not convenient to the user.

### BRIEF SUMMARY OF THE INVENTION

This invention has to do with a utensil storage stand, which comprises a base, a column extending away from the base, a distal end on the column, and utensil engagement means rotatably mounted on the column. The utensil engagement means is mounted on the column a spaced distance from the base, usually the distal end of the column, by a ball bearing arrangement comprising plastic or ceramic races, co-operating with plastic or ceramic bearings interposed between the races. The utensil engagement means comprises radially extending spokes with enlarged perforations through the spokes and utensil support hooks extending outwardly from the spokes. The utensil engagement means is rotatably mounted with respect to the column having an axis substantially perpendicular to the plane of the base. The radial support spokes preferably have enlarged perforations and hooks so that utensils may be stored and efficiently positioned on the storage stand.

The utensil engagement means comprises a co-operating element for connecting to the column, a disk having a bearing housing area, a bearing in said bearing housing area comprised of plastic inner and outer races with plastic or ceramic bearing interposed between the races. Radially extending spokes from the disk have enlarged perforations formed therein with outwardly extending hooks with upwardly facing ends located thereon. The perforations will be spaced along the spokes and sized so as to allow utensil handles to pass therethrough for storage on the utensil storage stand. The upwardly facing hooks are preferably formed as pegs on the periphery of the perforations, with the hooks having upwardly turned ends on the pegs. Preferably there will also be hooks or pegs with upturned ends located between the column and the perforation and the hooks or will form an acute angle of acute angle of 53 degrees plus or minus 5 degrees with the central longitudinal axis of the spokes. The utility engagement means located at a spaced distance from the support base may also be comprised of a polygonally sided disc with the spokes radially extending from the outer periphery of the polygonally sided disc. The perforations for holding the utensil handles are then formed in the polygonally sided disc.

### BRIEF DESCRIPTION OF THE DRAWINGS

FIG. 1 is a top view of the utensil storage stand according to the present invention.

FIG. 2 is a side view of the utensil storage stand according to the present invention.

FIG. 3 is a view 3-3 through FIG. 2 of the utensil storage stand according to the present invention.

FIG. 4 is a sectional view 4-4 through FIG. 2 of the utensil storage stand according to the present invention.

FIG. 5 is an exploded view of the utensil storage stand according to the present invention.

FIG. 6 is a cross sectional view 6-6 through FIG. 4 of the Utensil Storage Stand according to the present invention.

FIG. 7 is a view 7-7 through FIG. 4 of the Utensil Storage Stand according to the present invention.

### OBJECTS OF THE INVENTION

It is an object of the present invention to provide convenient storage facility for kitchen utensils.

It is an object of the present invention to organize kitchen utensils on a convenient countertop location.

It is an object of the present invention to provide a kitchen utensil stand that allows kitchen utensils to be easily stored and removed.

It is an object of the present invention to provide a kitchen utensil organizer that is compact and easily accessible.

It is an object of the present invention to provide a lazy-susan type of kitchen utensil organizer.

It is an object of the present invention to provide a kitchen utensil stand with rotating storage hooks for hanging kitchen utensils thereon.

It is a further object of the present invention to provide a utensil storage stand that will compactly store at least 15 utensils at one time.

It is a further object of the present invention to provide a storage stand having open perforations and hooks for easy compact and convenient access and storage.

It is an object of the present invention to provide an easy assembled and/or disassembled utensil storage stand, which the stand is, comprised three individual pieces of a base, a column and a utensil engagement top.

It is an object of the present invention to provide a lightweight, compact utensil storage stand that may be disassembled into three pieces for shipping.

### DETAILED DESCRIPTION OF THE DRAWINGS

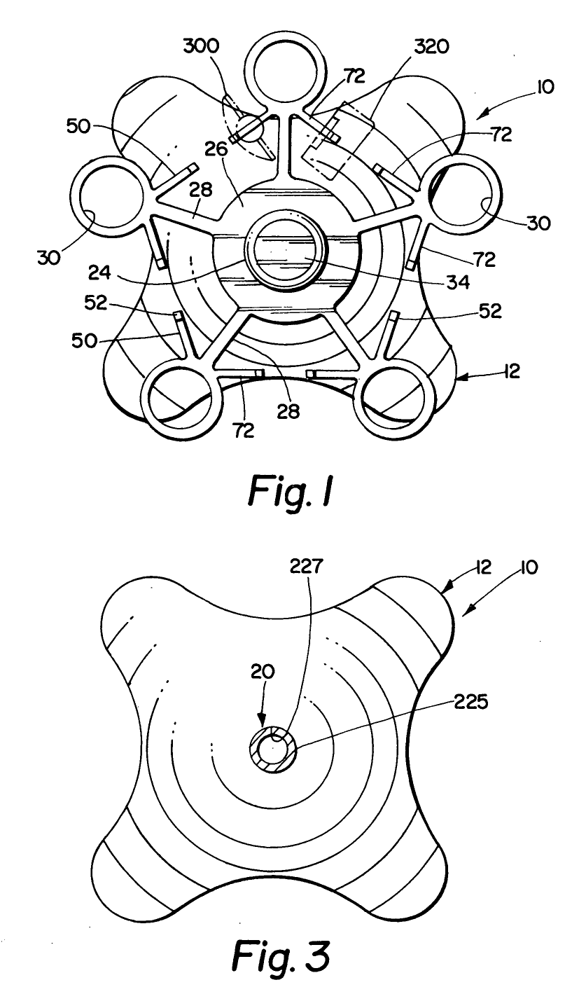

What is shown in FIG. 1 is the utensil storage stand 10 having a support base shown at 12. The support base 12 joins a column 20 that arises and extends away from the support base 12 until it comes to an upper utensil engagement means 22. The upper utensil engagement means 22 is rotatable with respect to the base 12 and has means 24 on the column for allowing rotation of the utensil means 22. The utensil means 22 comprises a disc 26 having spokes 28 immediately extending from the disc 26 and having enlarged perforations 30 on the spokes 28 with each perforation 30 so that the handle of a utensil 31 may extend through the perforation 30 and towards the support base 12. On the outer perimeter of the perforation 30 are upwardly facing hooks 50 shown on the periphery of the perforation 30 with upwardly extending sections 52 thereon forming an upwardly facing hook on the utensil engagement means 22. Inwardly of the perforation 30 on the spokes 28 are two upwardly facing hooks 72 which preferably form an acute included angle with the longitudinal axis of the spokes 28 of approximately 53 degrees plus/minus five degrees. (Hooks 72 differ from the other hooks only in the fact that 72 designates the hooks having the specific relationship of the acute angle. The acute angle of 53 degrees allows utensils to be hung so as to have easy access on the stand and provide more space for storage. When the hooks are arranged at such angles the utensils, when hung on the hooks, will usually have their widest part facing each other with their narrowest dimension extending in a radial direction from the central column of the stand. The preferable arrangement is that there will be five spokes 28 on the disc means 26 and each spoke 28 will have at least one, most preferably two, upwardly facing hooks 50 on said arrangement.

FIG. 1 also shows a main advantage of the present invention. The spoon 300 is shown with its handle 31 inserted down through a perforation 30 and hanging with its spoon end engaged the outer diameter of the perforation 30. The measuring cup 320 is shown hanging on a hook 72 that is acutely angled with the axis of the spoke 28. The broad dimension of cup 320 is not facing outwardly of the utensil stand. Another measuring cup hung on an opposing hook 72 will have its broader side facing the previous measuring cup. In this way more utensils can be fit around the circumference of the stand than if they faced outwardly.

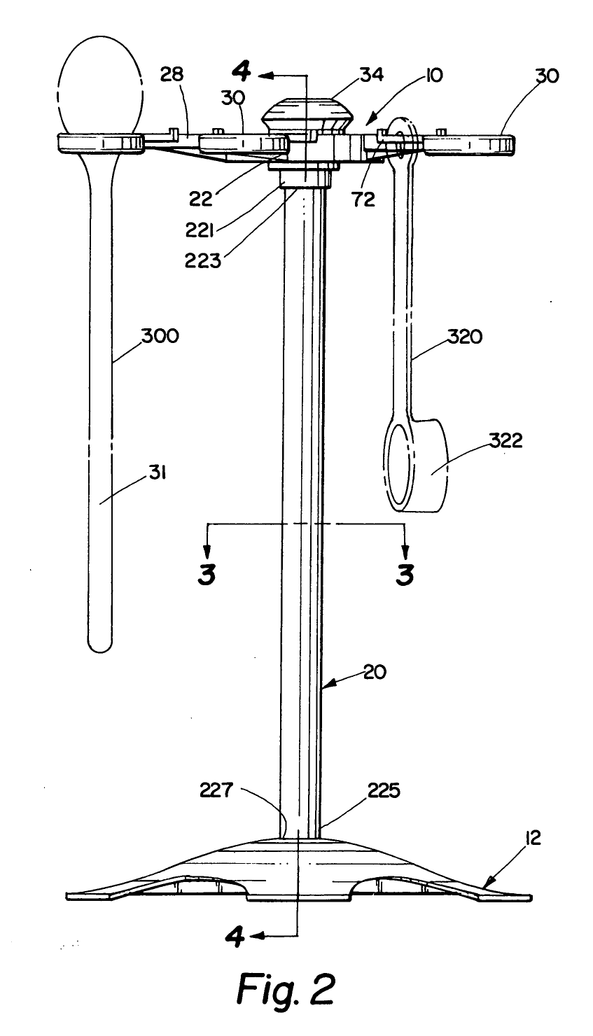

What is shown in FIG. 2 is a side view of the utensil storage stand according to the present invention. The utensil storage stand 10 has a base 12 with a column 20 extending up from the base to an upper utensil engagement means 22. The utensil engagement means 22 has co-operating elements of releasable attachment shown at 221 and 223. The column 20 extends into telescopic engagement with the utensil engagement means 22 through the cooperating elements 221 and 223. Shown on the utensil engagement means 22 are the perforations 30 with the spokes 28 extending out from the disc 26. The knob 34 is shown attached to the upper portion of the utensil engagement means 22 as such as the knob 34 may be grasped by a person's fingers and the top part rotated so that different utensil are presented to the front of the page. Shown at the lower part of FIG. 2 are cooperating elements of releasable attachment shown 225 and 227, in that 225 being at one end of the column 20 and 227 being a hole or perforation formed in the base 12 to except the end 225 of the column 20. In 225 of the column 20 will be telescopically engaged in hole 227 formed in the base 12. Base 12 has struts 229 that are tapered ribs that form a strengthening effect on the bottom of the base 12. The spokes 28 are shown having the perforation 30 with the hooks 50 that extend from the spokes 28.

What is shown in FIG. 3 is the top view of the base 12 with the perforation 227 shown therein, having the column 20 shown with its end 225 in the perforation 227, as can be seen therein, there will be a friction pressed fit between the end 225 of the column 20 and perforational hole 227 formed in the base 12. Tapered ribs on the sides of said perforation engage the column end 225 so as to provide an increasing tight fit as the column end 225 is telescopically engaged in hole 227.

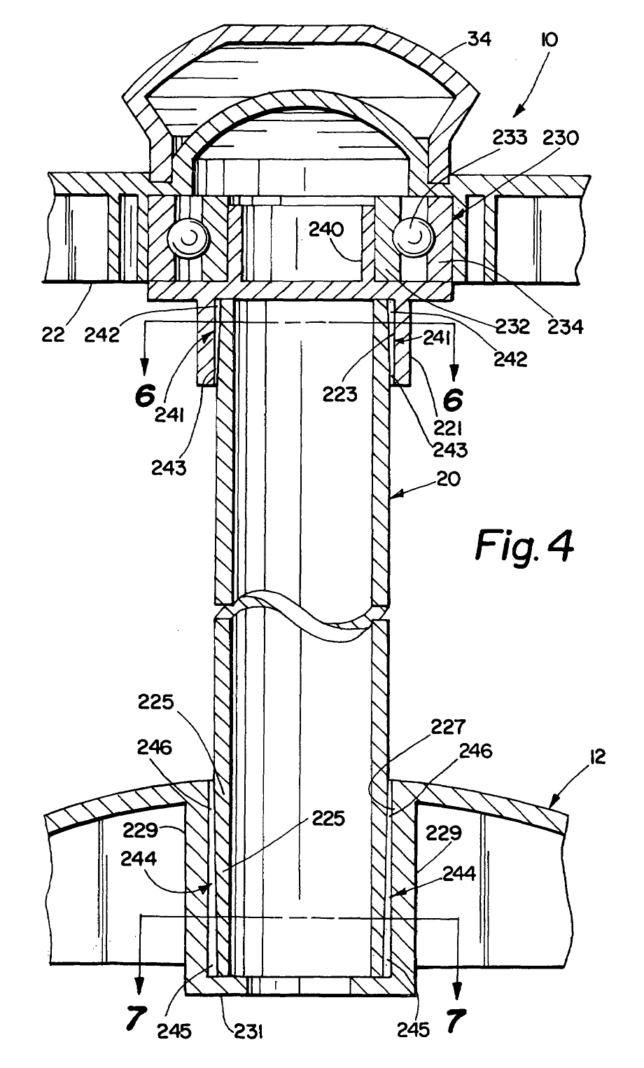

What is shown in FIG. 4 is a cross sectional view 4-4 through FIG. 2 of the utensil storage means 10 according to the present invention. The utensil storage means 10 has the column 20 that extends from the base 12 with the perforation 227 shown formed in the base 12. The perforation 227 has sidewalls 229 and a base 231 as such that the end 225 of column 20 can be telescopically pressed and engaged into the hole 227. On the top of the column 20 is shown the end 223 of the column 20 as it engages with the cooperating element of attachment 221. A cooperating element of attachment 221 is a circular tube like portion extending down from the utensil engagement means 22 and is telescopically engaged within 223 of the column 20. The end 223 again forms a friction fit with the element 221 such that the parts may be easily assembled or disassembled, and when pressed together, will tend to stay in an assembled configuration. The knob 34 is attached to the disc 26 that houses the plastic bearing race shown at 230 and 232. The bear race 230 is tightly fitted within the housing wall shown at 234 and an inner-race 232 is press fit over the up standing tubular or diameter portion 240 shown on the utensil engagement means 22. A ceramic bearing 233 is interposed between the inter-race 232 and the outer race 234 as such that the bearing means 233 holds the inter-race 232 in position with regard to outer race 234. Inter race 232 is rotatable in relation to 234 because of the bearings 233, but is not linearly displaceable along the axis of the column 20. Preferably, the bearing races 232 and 234 are made of a plastic material and the bearing 233 is made of a ceramic material. It is however possible that all or both of the races and the bearings could be made of a ceramic material and/or a plastic material. It is preferable that the bearing however comprised of plastic and ceramic with the plastic forming the bearing races and the ceramic material forming the bearing material between the bearing races.

What also is shown in FIG. 4 is the upper end 221 of the column 20 that is a pressed fit into the utility engagement means. The upper rib 241 is shown having a base portion 242 that tapers lower to the other portion 243 of the ribs as such that the end 221 of the column 20 will have cooperation elements that press fit between the two parts. Shown also in the lower portion of FIG. 4 is the base portion of the lower rib 245 having a top thinner section 246 of the lower rib 244. The lower rib 244 is tapered also so that the rib is thinner at the top 246 than at the base 245. In this manner the end 225 of the column 20 may then be pressed fit into the base and held together in that fashion.

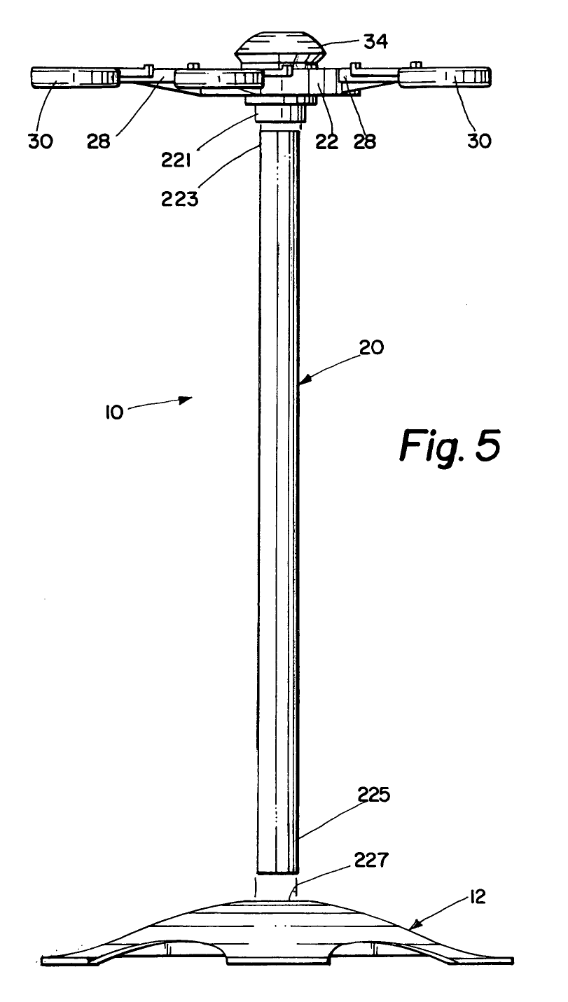

What is shown in FIG. 5 is a side view of the disassembled or exploded view of the utility stand 10. The utility stand has been disclosed having a base 12, a column 20 and a utility engagement means 22. The opposing ends 223 and 225 of the column 20 are shown with the end 223 separated from its cooperating element of engagement means 221. End 223 is designed so that it will telescopically fit within the hole or receiving area of element 221 and that the friction between the interference fit provided by the diameters of those members will hold the pieces together with a reasonable degree of force as such that it will not come apart during normal use. The knob 34 is shown on top with the perforations 30 and the spokes 28 extending out from the disc on the utensil engagement means 22.

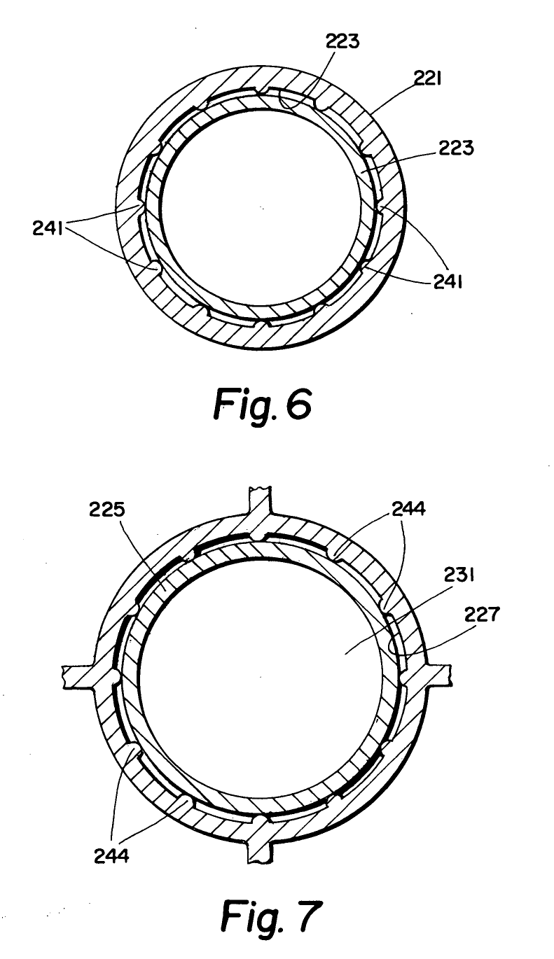

What is shown in FIG. 6 is the cooperating elements of telescopic engagement 221 and 223. The column end 223 goes within the cooperation element of abutment 221. The internal hole 221 in the housing has the ribs 251 that are increasingly tapered as they go from the top to the bottom of the hole. These tapers as shown 251 form a friction fit as shown in 253 with the end 223 of the column 20. In this manner, the end 223 of the column may be pulled or pushed into and out of engagement with the hole 221.

What is shown in FIG. 7 is the end 925 of the column 20 as it fits in the hole 227 shown in the base 12. The hole 227 has tapered ribs 261 that engage the end 225 of the column 20 as such that the end 225 may be pushed into and out of telescopic engagement with the hole 227 and the base 12. The ribs 261 are again tapered as they extend.

We claim:

1. The utensil storage stand which comprises:
a. a support base;
b. a central column extending away from said support base;
c. utensil engagement means rotatably mounted on said column a spaced distance from said support base;
d. said utensil engagement means having a disk and a bearing housed in said disk which is comprised of both a plastic and ceramic material with said bearing interposed between said column and said utensil engagement means;
e. radial spokes extending away from said disk with perforations in said spokes; and,
f. hook legs extending outwardly from said spokes.

2. The utensil storage stand according to claim 1 in which said utensil engagement means comprises hook means on the outer periphery of said perforation.

3. The utensil storage stand according to claim 1 in which said hook means on said spokes form an acute angle of 53 degrees plus or minus 5 degrees with the axis of said spoke.

4. The utensil storage stand according to claim 1 which further comprises said column and said support base having releasable and co-operative elements of telescopic engagement with one another.

5. The utensil storage stand according to claim 4 which further comprises releasable elements of telescopic engagement between said column and said utility engagement disk.

6. The utensil storage stand which comprises:
a. a support base;
b. a central column extending away from said support base;
c. utensil engagement means rotatably mounted on said column a spaced distance from said support base;
d. releasable means of attachment between said base and said column.
e. releasable means of attachment between said column and said utensil engagement means;
f. radial spokes on said utensil engagement means extending outwardly from said column with perforations formed in said outer ends; and,
g. hook legs extending outwardly from said spokes intermediate of said disk and said perforations.

7. The utensil storage stand according to claim 6 in which said releasable attachment means comprises co-operating elements of telescopic engagement.

8. The utensil storage stand according to claim 7 in which the releasable attachment means further comprises a press fit between said co-operating elements of telescopic engagement.
